(19) United States
(12) Patent Application Publication
(10) Pub. No.: US 2018/0306891 A1
(43) Pub. Date: Oct. 25, 2018

(54) METHOD AND DEVICE FOR IMPROVING RF SIGNAL PROCESSING

(71) Applicant: QUALCOMM Incorporated, San Diego, CA (US)

(72) Inventor: Rayman Pon, Cupertino, CA (US)

(21) Appl. No.: 15/709,299

(22) Filed: Sep. 19, 2017

Related U.S. Application Data
(60) Provisional application No. 62/487,427, filed on Apr. 19, 2017.

(51) Int. Cl. G01S 5/02; H04W 4/02

(52) U.S. Cl. CPC G01S 5/02; H04L 67/12; H04W 4/02

(57) ABSTRACT

Disclosed are a system, apparatus, and method for refined RF signal processing of a received low bandwidth signal. A first time domain RF signal is received and converted from a time based domain to a frequency based domain. A second time domain RF signal is received at a time after the first time domain RF signal and converted from a time based domain to a frequency based domain. At least the converted first RF signal and the converted second RF signal are combined, where one or both of: the converted first RF signal, or the converted second RF signal are rotated in the frequency domain for the combining. A refined time domain peak is determined from the combined RF signal.

### PRIORITY

This application claims the benefit of U.S. Provisional Application No. 62/487,427, titled “Method and Device for Improving RF Signal Processing,” filed on Apr. 19, 2017.

### FIELD

The subject matter disclosed herein relates generally to improving time of arrival accuracy.

### BACKGROUND

Inexpensively mass produced devices often comprise inexpensive hardware to cut costs. For example, smart/connected devices that make up the Internet of Things (IoT) are becoming more and more prevalent in homes and businesses. Many of these IoT devices utilize radio frequency (RF) based position location systems that utilize time of arrival (TOA) of a radio signal. Due to cost considerations, minimizing the radio transceiver, battery, and processing requirements can reduce hardware requirements. Therefore, inexpensive low power devices are likely to utilize low bandwidth communication to keep costs and power usage low. However wide/high bandwidth signals typically require more expensive and complex radio systems than narrow/low bandwidth systems. Also, as more devices and systems are added to an already busy radio spectrum available bandwidth may become more limited. Unfortunately, low bandwidth radio systems typically suffer from decreased accuracy compared to the more expensive high bandwidth capable systems. Correlation of TOA peak width is inversely proportional to signal bandwidth. The smaller the bandwidth, the wider the TOA peak width, and the less accuracy to determine the actual TOA peak or separate particular RF signals from multipath and noise. Therefore, new and improved low bandwidth refined RF signal processing techniques are desirable.

### BRIEF SUMMARY

In one aspect, a computer-implemented method refines a radio frequency (RF) signal at a device, the method comprising: receiving a first RF signal; converting, the first RF signal from time based domain to frequency based domain; receiving a second RF signal, sampled at a time after the first RF signal; converting the second RF signal from time based domain to frequency based domain; shifting, in frequency based domain, one or both of: the converted first RF signal, or the converted second RF signal; combining at least the converted first RF signal and the converted second RF signal into a combined RF signal; and determining a refined RF signal measurement from the combined RF signal.

In another aspect, a machine readable non-transitory storage medium stores program instructions executable by a processor to: receive a first RF signal; convert, the first RF signal from time based domain to frequency based domain; receive a second RF signal, sampled at a time after the first RF signal; convert the second RF signal from time based domain to frequency based domain; shift, in frequency based domain, one or both of: the converted first RF signal, or the converted second RF signal; combine at least the converted first RF signal and the converted second RF signal into a combined RF signal; and determine a refined RF signal measurement from the combined RF signal.

In yet another aspect, a device refines a radio frequency (RF) signal comprising: memory; and a processor coupled to the memory and configured to: receive a first RF signal; convert, the first RF signal from time based domain to frequency based domain; receive a second RF signal, sampled at a time after the first RF signal; convert the second RF signal from time based domain to frequency based domain; shift, in frequency based domain, one or both of: the converted first RF signal, or the converted second RF signal; combine at least the converted first RF signal and the converted second RF signal into a combined RF signal; and determine a refined RF signal measurement from the combined RF signal.

In a further aspect, an apparatus comprises: means for receiving a first RF signal; means for converting, the first RF signal from time based domain to frequency based domain; means for receiving a second RF signal, sampled at a time after the first RF signal; means for converting the second RF signal from time based domain to frequency based domain; means for shifting, in frequency based domain, one or both of: the converted first RF signal, or the converted second RF signal; means for combining at least the converted first RF signal and the converted second RF signal into a combined RF signal; and means for determining a refined RF signal measurement from the combined RF signal.

The above and other aspects, objects, and features of the present disclosure will become apparent from the following description of various embodiments, given in conjunction with the accompanying drawings.

### BRIEF DESCRIPTION OF THE DRAWINGS

FIG. 1 is a flow diagram of a method for implementing refined RF signal processing in one embodiment.

FIG. 2 is a flow diagram of a method for implementing refined RF signal processing in another embodiment.

FIG. 3 illustrates an exemplary device to implement refined RF signal processing.

### DETAILED DESCRIPTION

The word “exemplary” or “example” is used herein to mean “serving as an example, instance, or illustration.” Any aspect or embodiment described herein as “exemplary” or as an “example” is not necessarily to be construed as preferred or advantageous over other aspects or embodiments.

Some embodiments discussed herein provide for refined RF signal processing of a received low bandwidth signal. In one embodiment, refined RF signal processing synthetically increases the RF signal's original bandwidth (BW) which narrows the TOA peak thereby increasing accuracy of TOA calculation. In some embodiments, the refined RF signal can provide for improved multipath detection and reduction of correlated noise. For example, the refined RF signal can resolve and differentiate multipath peaks and noise from the TOA peak.

In one embodiment, to refine an incoming RF signal two or more time-based radio frequency (RF) signal samples (for example, one or more RF signals sampled at a time after a first RF signal sample) are received at a device (for example, an IoT device or other low power, low cost device). A RF signal sample may be converted by fast Fourier transform from time based domain to frequency based domain. In some embodiments, an inverse fast Fourier transform (IFFT) of one or both of the RF signals in the frequency based domain estimates the TOA peak in time domain. In one embodiment, the TOA peak is determined from coherently combining two or more converted (for example, via IFFT) RF signal samples resulting in an estimate of the peak of the coherently combined signal. One or both of the converted RF signal samples may be shifted in the frequency domain and then the shifted RF signal may be combined to determine a refined TOA peak estimation (i.e., synthetically increasing the bandwidth of a low(er) bandwidth original RF signal sample). In some embodiments, the original time shift applied to one or more RF signal samples may be subtracted to determine final TOA estimation.

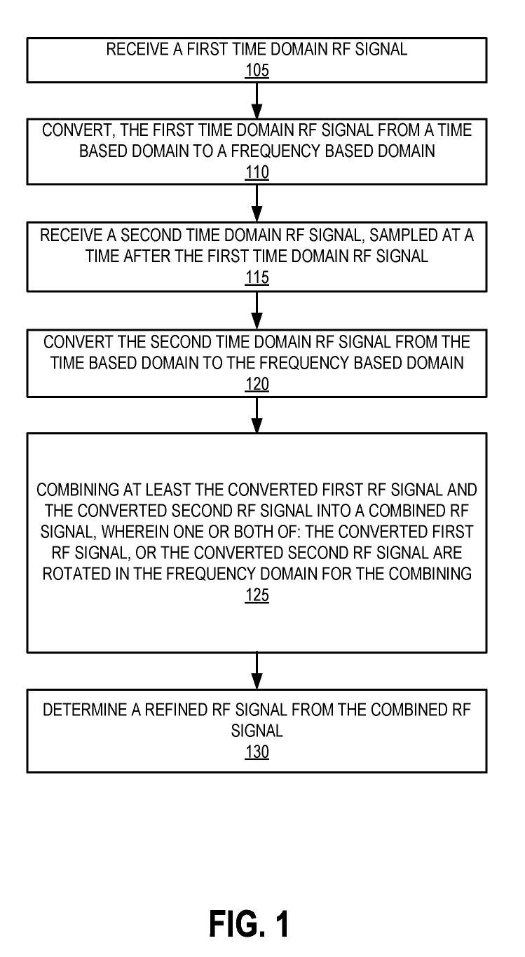

FIG. 1 is a flow diagram of a method for refined RF signal processing in one embodiment. At block 105, an embodiment (for example, the method implemented by a refined RF signal processing module or by refined RF signal processing enabled device) receives a first time domain RF signal. Means for performing the functionality of block 105 can include, but are not limited to, wireless device 300, one or more of wireless subsystems 315, cellular subsystem 361, RF transceiver 380, network interface 310, and/or processor(s) 301.

At block 110, the embodiment converts the first time domain RF signal from a time based domain to a frequency based domain. For example, the conversion to frequency based domain may be implemented by Fast Fourier Transform (FFT) of the first RF signal. In some embodiments, the result of the FFT may be vector bins.

At block 115, the embodiment receives a second time domain RF signal, sampled at a time after the first time domain RF signal. For example, the second RF signal may be a next immediate RF signal after the first RF signal, or in some embodiments, a refined RF signal processing enabled device may sample a different RF signal at some time subsequent to the first RF signal. The second RF signal may be sampled at any time after the first signal when the refined RF signal processing enabled device has not moved an appreciable distance. For example, the appreciable distance may be determined according to a user configurable distance or movement threshold associated with the device. Mobile device sensors or other techniques known in the art may be used to determine movement of the device. Some IoT devices implementing refined RF signal processing may move relatively infrequently and therefore can sample signals hours, days, or longer time periods apart because the IoT device is located in approximately the same position at time of receipt of both the first RF signal and the second (or whichever subsequent position) RF signal.

In some embodiments, in response to converting the first RF signal, a first TOA peak estimate is determined (for example, by the device implementing refined RF signal processing). The first TOA peak estimation may be determined by one or more of: correlating with a RF reference signal (for example, PRS or CRS), descrambling of the first RF signal, or any combination thereof.

At block 120, the embodiment converts the second time domain RF signal from the time based domain to the frequency based domain. In some embodiments, the second RF signal comprises a same frequency block as the first RF signal. In some embodiments, a third RF signal comprises a different frequency block than one or both of the first RF signal or the second RF signal.

At block 125, the embodiment combines at least the converted first RF signal and the converted second RF signal into a combined RF signal, wherein one or both of: the converted first RF signal, or the converted second RF signal are rotated in the frequency domain for the combining. In one embodiment, the combining comprises time shifting one or more signals to a common time frame.

At block 130, the embodiment determines a refined time domain peak from the combined RF signal. In one embodiment, the refined RF signal is an IFFT of the combined converted RF signals which results in a refined TOA peak. In other embodiments, the refined RF signal provides for enhanced multipath or correlated noise reduction from the original received low bandwidth RF signal.

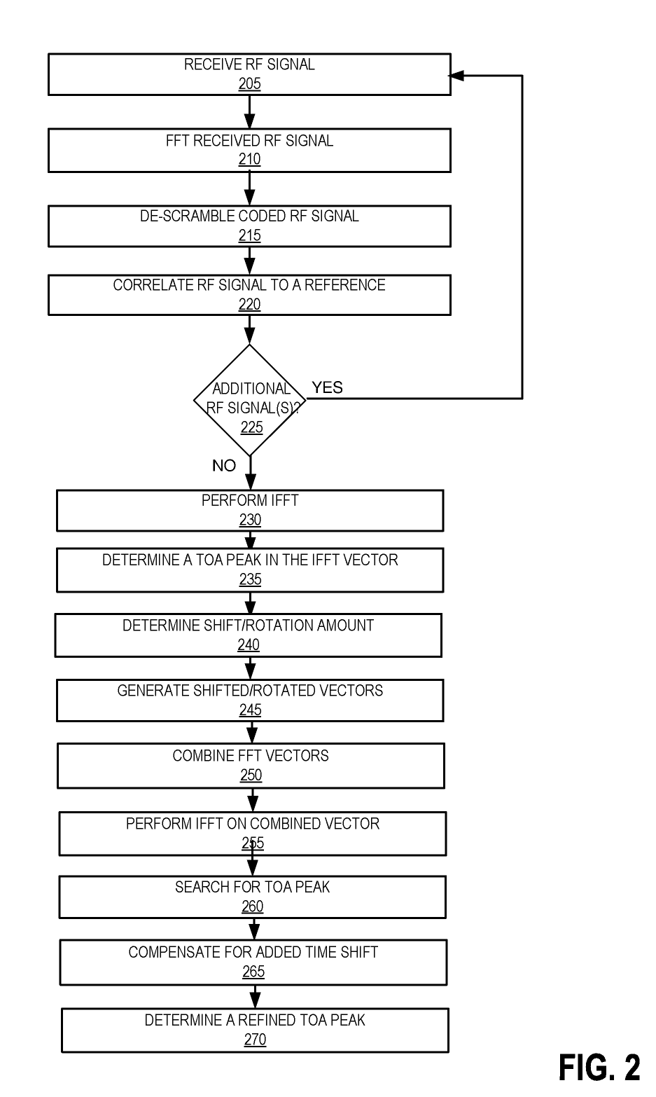

FIG. 2 is a flow diagram of a method for implementing refined RF signal processing in another embodiment. At block 205, an embodiment (for example, a method implemented by a refined RF signal processing module or enabled device) receives an RF signal. For example, the device may receive an RF signal sample from a base station. In some embodiments, the device may receive and process the RF signal at the device. In some embodiments, the device may receive the RF signal and send a representation of the received RF signal to a server for processing instead of or in addition to processing one or more aspects of the signal at the device. In some embodiments, in response to the device receiving an RF signal the device sends back measurement data or a position of the device.

At block 210, the embodiment performs FFT on the received RF signal. For example, FFT of the received RF signal converts the RF signal from the time based domain to the frequency based domain. The output of the FFT can result in vector bins.

At block 215, the embodiment de-scrambles the coded signal. For example, the original received RF signal may be scrambled according to a transmission code and therefore the refined RF signal processing enabled device may have to de-scramble in order to continue further processing. If the signal is not scrambled or encoded, the embodiment skips block 215 and proceeds directly to block 220 below.

At block 220, the embodiment correlates the received RF signal to a reference RF signal. Correlation in frequency domain may be a complex conjugate multiplication equivalent to a correlation in time domain. In one embodiment, the refined RF signal processing enabled device determines a baseline or reference RF signal for comparing incoming RF signals. In some embodiments, the baseline or reference RF signal may be determined according to for example, a transfer specification. For example, with regards the Long-Term Evolution (LTE) telephone and mobile broadband communication standard, a baseline or reference RF signal may be determined from the Physical Cell ID (PCI) of the LTE base station transmitting the incoming RF signal. In some embodiments the baseline from various types of incoming RF signals and base stations may be leveraged according to their particular transfer specification to establish a baseline or reference RF signal as used herein. In some embodiments, as a result of correlating at block 220, the embodiment outputs vectors in “N” number of bins.

At block 225, the embodiment determines whether to process additional RF signal(s). If more signals are to be processed (for example, if there is only one RF signal received thus far), the embodiment returns to block 205 and continues the process as above. Alternatively, if there have been sufficient (for example, as determined by a configuration or user) RF signals received, the embodiment may proceed to 230 below to estimate TOA peak. In some embodiments, the differences between received RF signals is attributable to noise. In one embodiment, at least two RF signals are used to refine the TOA determination, however additional RF signals may be used. In some embodiments, the device is assumed to not have moved appreciably during the collection of additional RF signals. For example, the signals may be collected within a narrow time period or other movement/position checks may be implemented such that all the received RF signals are obtained within approximately the same location.

At block 230, the embodiment performs inverse fast Fourier transform (IFFT). In some embodiments, all received RF signals through block 225 may be coherently combined before determining the TOA peak of the coherently combined RF signal below.

At block 235, the embodiment determines an TOA peak in the IFFT vector. IFFT of block 230 may be used to determine a first estimate of the TOA peak in time based domain. For example, the first estimated TOA Peak may be based on the received RF signals through block 225 for which there can be multiple. The index corresponding to the estimated peak may be an estimated index (and may not be an integer value) determined from the TOA peak.

At block 240, the embodiment determines, based on the determined index corresponding to the estimated peak, a shift (or rotation) amount. For example, the shift amount may be based at least in part on estimated index determined from the TOA peak determined at block 235.

In one embodiment, for a frequency block A, an appropriate shift amount may be determined by:

Discrete Fourier Transform (i.e., DFT)[xn]ₖ=Xk Eq. 1

Taking a shifted version of the frequency vector in the frequency domain, yields the same time domain vector, but with phase shifted components:

$$D F {T [ {xne}^{2 Pi \frac{i}{N} nm} ]}_{k} = {X}_{k - m} \qquad Eq . 2$$

And:

$$D F T [ {x}_{n - m} ] k = Xk {e}^{- 2 Pi \frac{i}{N} km} \qquad Eq . 3$$

In one embodiment, an original RF signal sample is summed in the time domain with the additional vector (for example, IFFT is linear operation) having phase shifted components according to Eq. 2 above. In one embodiment, if the TOA peak of interest has identical phase for the summed vectors, the main peak width is reduced when the vectors are summed. In one embodiment, the ideal occurs when nm mod N=0 at the TOA peak of interest.

In one embodiment, a first TOA estimate is determined using traditional methods so that an approximate peak location may be shifted to desired point n in Eq. 1-3 above. Frequency domain phase rotations according to Eq. 3 can be used to obtain a frequency domain vector, and the frequency domain vector may be shifted by the predetermined amount and added to a prior determined vector. In one embodiment, IFFT is performed on the extended frequency domain vector. In some embodiments, inverse discrete Fourier transform (inverse DFT) may be applied to a smaller subset of points less than N, because of the initial TOA peak estimate.

In one embodiment, “n”, “m”, and “N” values from Eq. 1-3 above are selected such that there is little sensitivity in the output result for errors in “n” which is the estimated peak index location from a first pass IFFT. In one embodiment, as large an “N” as possible is selected to reduce impact of nm mod N=0 errors. In one embodiment, “m” is set as large as possible for widest frequency overall bandwidth, but errors in “n” are multiplied by “m” which may cause phase errors from the ideal nm mod N=0. Phase errors may influence the maximum ideal value for “m” in some embodiments. In one embodiment, values for nm mod N away from zero are divided by N to produce a phase error from ideal, degrading the time domain vector sum from the ideal. For example, with the case of “m”=0, the result becomes identical to coherent combining of RF signals.

In some embodiments, two or more additional frequency vectors (for example, several blocks of data) are applied to effectively further increase bandwidth. In one embodiment, a user can control for “n” (time domain sample number), “m” (frequency domain shift amount), and “N” (IFFT length).

At block 245, the embodiment generates rotated and shifted vectors in frequency domain. In one embodiment, when shifting in frequency domain, the TOA peak computed before determines the time shift to place the TOA peak at the center of the time domain vector, to place the TOA peak at the origin of the time domain vector, or to place the TOA peak at any index in the time domain vector such that the combined frequency domain vectors do not overlap.

The time domain vectors may be rotated in the frequency domain according to Eq. 3 above. In one embodiment, the position (for example, center, beginning, end, etc.) within the time domain vector is based on making (n)*(m) mod N=0 where “n” is the index in the time domain vector, “m” is the shift amount in the frequency domain to combine the vectors before the IFFT, and “N” is the length of the vector. When the position of the index is in the center of the time domain vector (n)*(m) mod N=0 whenever m is even. For example, when N=2048 then n=1024 and then (n)*(m) mod N=0 for any m that is even. Therefore, for any even m it becomes easier to find a desired shift amount such that the combined frequency domain vectors do not overlap.

At block 250, the embodiment combines rotated and shifted vectors as determined in block 245. For example, to shift/rotate the frequency, an estimated TOA Peak (i.e., a measurement in time) is shifted in time (i.e., the rotation in frequency) to a convenient ‘n’ integer.

At block 255, the embodiment performs IFFT on the combined vector. In one embodiment, multiple prior FFT vectors of previous blocks are combined at prior block 250 such that one combined vector remains as input for IFFT at block 255.

At block 260, the embodiment searches for a TOA Peak on the inverse transformed combined vector.

At block 265, the embodiment compensates for the added time shift introduced at block 240. For example, to remove the original time shift from the previous processing, shift compensation may include estimating the peak from Equation 3 above and moving to the center of a time sample so that any even integer ‘m’ will represent a shift in frequency.

At block 270, the embodiment determines a refined TOA peak based on the TOA Peak of block 260 and the compensation of block 265. In some embodiments, the refined RF signal provides for enhanced multipath or correlated noise reduction from the original received low bandwidth RF signal.

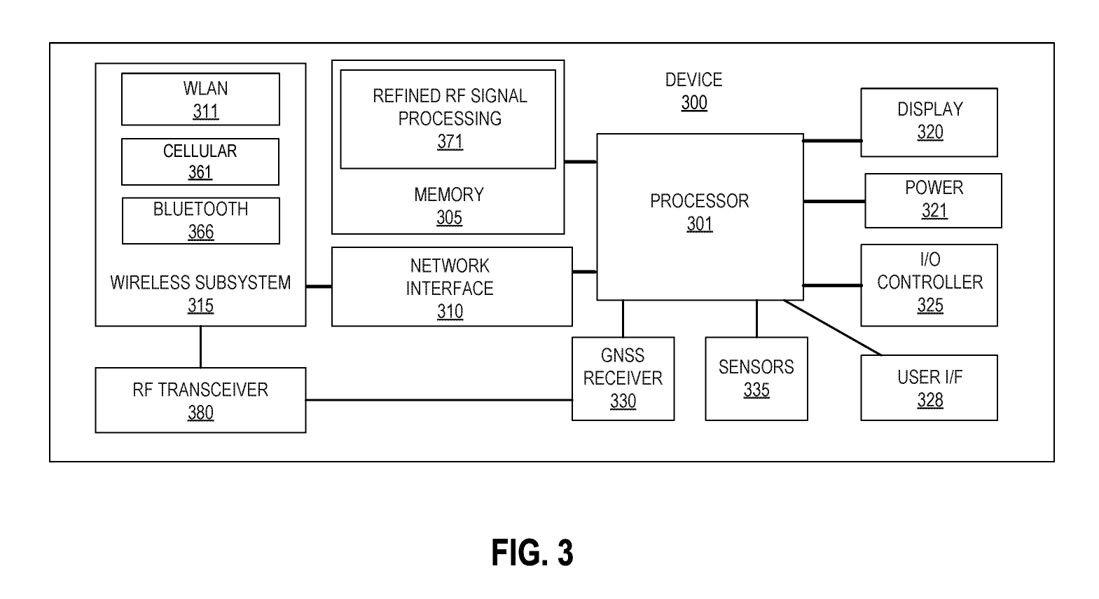

FIG. 3 is block diagram illustrating a device to perform refined RF signal processing, in one embodiment. Wireless device 300 may include one or more processor(s) 301 (for example, a general purpose processor, specialized processor, or digital signal processor), a memory 305, I/O controller 325, and network interface 310. It should be appreciated that wireless device 300 may also include a display 320, a user interface (I/F) 328 (for example, keyboard, touch-screen, or similar devices), a power device 321 (for example, a battery or power supply), as well as other components typically associated with electronic devices. In some embodiments, wireless device 300 may be a mobile or non-mobile device.

The wireless device 300 may also include a number of device sensors 335 coupled to one or more buses or signal lines further coupled to the processor(s) 301. The sensors 335 may include a clock, ambient light sensor (ALS), accelerometer, gyroscope, magnetometer, temperature sensor, barometric pressure sensor, red-green-blue (RGB) color sensor, ultra-violet (UV) sensor, UV-A sensor, UV-B sensor, compass, proximity sensor. The wireless device may also include a Global Positioning System (GPS) or global navigation satellite system (GNSS) receiver 330 which may enable GPS or GNSS measurements in support of A-GNSS positioning. In some embodiments, multiple cameras are integrated or accessible to the wireless device. In some embodiments, other sensors may also have multiple versions or types within a single wireless device.

Memory 305 may be coupled to processor(s) 301 to store instructions (for example, instructions to perform the functionality of the refined RF signal processing module 371) for execution by processor(s) 301. In some embodiments, memory 305 is non-transitory. Memory 305 may also store software or firmware instructions (e.g. for one or more programs or modules) to implement embodiments described herein such as refined RF signal processing embodiments described in association with FIGS. 1, and 2. Thus, the memory 305 is a processor-readable memory and/or a computer-readable memory that stores software code (programming code, instructions, etc.) configured to instruct and/or cause the processor(s) 301 to perform the functions described herein. Alternatively, one or more functions of refined RF signal processing may be performed in whole or in part in device hardware.

Memory 305 may also store data from integrated or external sensors. In addition, memory 305 may store application program interfaces (APIs) for providing access to one or more features of refined RF signal processing as described herein. In some embodiments, refined RF signal processing functionality can be implemented in memory 305. In other embodiments, refined RF signal processing functionality can be implemented as a module separate from other elements in the wireless device 300. The refined RF signal processing module may be wholly or partially implemented by other elements illustrated in FIG. 3, for example in the processor(s) 301 and/or memory 305, or in one or more other elements of the wireless device 300.

Network interface 310 may also be coupled to a number of wireless subsystems 315 (for example, Bluetooth subsystem 366, wireless local area network (WLAN) subsystem 311, cellular subsystem 361, or other networks) to transmit and receive data streams through RF transceiver 380 to/from a wireless network or through a wired interface for direct connection to networks (for example, the Internet, Ethernet, or other wireline systems). Wireless subsystems 315 may be connected to RF transceiver 380. Transceiver 380 may be connected to GPS or GNSS receiver 330 to enable reception of GPS or other GNSS signals by GPS or GNSS receiver 330. RF transceiver 380 may include a single antenna, multiple antennas and/or an antenna array and may include antennas dedicated to receiving and/or transmitting one type of signal (e.g. cellular, WiFi or GNSS signals) and/or may include antennas that are shared for transmission and/or reception of multiple types of signals. WLAN subsystem 311 may comprise suitable devices, hardware, and/or software for communicating with and/or detecting signals from WiFi APs and/or other wireless devices within a network (e.g. femtocells). In one aspect, WLAN subsystem 311 may comprise a WiFi (802.11x) communication system suitable for communicating with one or more wireless access points.

Cellular subsystem 361 may be connected to RF transceiver 380 and to one or more antennas. The wide area network transceivers may comprise suitable devices, hardware, and/or software for communicating with and/or detecting signals to/from other wireless devices within a network. In one aspect, the wide area network transceivers may comprise a code division multiple access (CDMA) communication system suitable for communicating with a CDMA network of wireless base stations; however in other aspects, the wide area network transceivers may support communication with other cellular telephony networks or femtocells, such as, for example, time division multiple access (TDMA), Long-Term Evolution (LTE), Advanced LTE, Wideband Code Division Multiple Access (WCDMA), Universal Mobile Telecommunications System (UMTS), 4G, or Global System for Mobile Communications (GSM). Additionally, any other type of wireless networking technologies may be supported and used by wireless device 300, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT). Using AFLT, a server may compute a position for wireless device 300 from phase measurements made by wireless device 300 of pilot signals transmitted from a plurality of base stations.

In one embodiment, wireless device 300 implemented as a mobile device stores instructions (for example, within memory 305) executable by processor(s) 301 to determine a reference position, receive signals (for example, via network interface 310) from base transceiver stations (BTSs), and determine mobile device position based on signals from the BTSs. Memory 305 may also store instructions to detect one or more unreliable BTSs based mobile device positioning measurement quality based on the plurality of BTSs and/or range measurement quality. Wireless device 300 may also provide (for example, via network interface 310 and one or more of wireless subsystems 315) a status report including BTS data and mobile device data.

The device as used herein (for example, wireless device 300) may be a: wireless device, cell phone, IoT device, personal digital assistant, mobile computer, wearable device (for example, watch, head mounted display, virtual reality glasses, etc.), tablet, personal computer, laptop computer, or any type of device that has wireless capabilities. As used herein, a wireless device may be any portable, or movable device or machine that is configurable to acquire wireless signals transmitted from, and transmit wireless signals to, one or more wireless communication devices or networks. Thus, by way of example but not limitation, the wireless device 300 may include a radio device, a cellular telephone device, a computing device, a personal communication system device, or other like movable wireless communication equipped device, appliance, or machine. The term “device” is also intended to include devices which communicate with a personal navigation device, such as by short-range wireless, infrared, wireline connection, or other connection—regardless of whether satellite signal reception, assistance data reception, and/or position-related processing occurs at the wireless device 300. Also, the term “device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the wireless device, at a server, or at another wireless device associated with the network. Any operable combination of the above can also be considered a “device” as used herein. Other uses may also be possible. While various examples given in the description below relate to wireless devices, the techniques described herein can be applied to other devices.

The device may communicate wirelessly with a plurality of APs, base stations and/or femtocells using RF signals (for example, 300 MHz, 1900 MHz, 2.4 GHz, 3.6 GHz, and 4.9/5.0 GHz bands) and standardized protocols for the modulation of the RF signals and the exchanging of information. For example, the protocol may be Institute of Electrical and Electronics Engineers (IEEE) 802.11x or 3GPP LTE. By extracting different types of information from the exchanged signals, and utilizing the layout of the network (i.e., the network geometry) the wireless device may determine its position within a predefined reference coordinate system.

It should be appreciated that embodiments of the invention as will be hereinafter described may be implemented through the execution of instructions, for example as stored in the memory 305 or other element, by processor(s) 301 of wireless device 300 and/or other circuitry of wireless device 300 and/or other devices. Particularly, circuitry of wireless device 300, including but not limited to processor(s) 301, may operate under the control of a program, routine, or the execution of instructions to execute methods or processes in accordance with embodiments of the invention. For example, such a program may be implemented in firmware or software (e.g. stored in memory 305 and/or other locations) and may be implemented by processors, such as processor(s) 301, and/or other circuitry of wireless device 300. Further, it should be appreciated that the terms processor, microprocessor, circuitry, controller, etc., may refer to any type of logic or circuitry capable of executing logic, commands, instructions, software, firmware, functionality and the like.

Some or all of the functions, engines or modules described herein (for example, refined RF signal processing features and methods illustrated in at least FIGS. 1-2) may be performed by the wireless device 300 itself (for example, via instructions of refined RF signal processing module 371 stored in memory 305). For example, wireless device 300 (TOA) may comprise memory 305 and processor(s) 301 coupled to the memory.

In one embodiment, wireless device 300 is a low power device for determining a location using low bandwidth signals comprising memory (i.e, memory 305); an RF transceiver (i.e., RF transceiver 380) for receiving RF signals; and a processor coupled to the memory and to the RF transceiver and configured to: receive a first time domain RF signal; convert, the first time domain RF signal from a time based domain to a frequency based domain; receive a second time domain RF signal, sampled at a time after the first time domain RF signal; convert the second time domain RF signal from the time based domain to the frequency based domain; combine at least the converted first RF signal and the converted second RF signal into a combined RF signal, where one or both of: the converted first RF signal, or the converted second RF signal are rotated in the frequency domain for the combining; and determine a refined time domain peak from the combined RF signal.

In some embodiments, device 300 further includes instructions to: determine an amount for the rotation, where determining the amount for the rotation comprises: performing IFFT; and estimating a time domain peak. The refined time domain peak may include performing IFFT on the combined converted RF signals. In some embodiments, the second time domain RF signal comprises a same frequency block as the first time domain RF signal. In some embodiments device 300 also includes instructions to: receive a third time domain RF signal sampled after the first time domain RF signal and after the second time domain RF signal, where the third time domain RF signal comprises a different frequency block than one or both of the first RF signal or the second RF signal; perform FFT of the third time domain RF signal; and combine the third frequency based RF signal with the first time domain RF signal or the time domain second RF signals in the frequency domain, wherein the processor coupled to the memory and to the RF transceiver configured to determine the refined time domain peak comprises the processor coupled to the memory and to the RF transceiver configured to determine the refined time domain peak according to the combined RF signal that includes the third frequency based RF signal.

In some embodiments, wireless device 300 provides the means for implementing the refined RF signal processing described herein (for example, at least with respect to the features of FIGS. 1 and 2 above). For example device 300 may be an apparatus for determining a location using low bandwidth signals, the apparatus comprising: means for receiving a first time domain RF signal; means for converting, the first time domain RF signal from a time based domain to a frequency based domain; means for receiving a second time domain RF signal, sampled at a time after the first time domain RF signal; means for converting the second time domain RF signal from the time based domain to the frequency based domain; means for combining at least the converted first RF signal and the converted second RF signal into a combined RF signal, wherein one or both of: the converted first RF signal, or the converted second RF signal are rotated in the frequency domain for the combining; and means for determining a refined time domain peak from the combined RF signal.

In some embodiments or some or all of the functions, engines or modules described herein may be performed by another system connected through 110 controller 325 or network interface 310 (wirelessly or wired) to the device. Thus, some and/or all of the functions may be performed by another system and the results or intermediate calculations may be transferred back to the wireless device. In some embodiments, such other device may comprise a server configured to process information in real time or near real time. Further, one or more of the elements illustrated in FIG. 3 may be omitted from the wireless device 300. For example, one or more of the sensors 335 may be omitted in some embodiments.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (for example, a server or device). It will be recognized that various actions described herein can be performed by specific circuits (for example, application specific integrated circuits), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated one or more processors and/or instruct one or more processors to perform the functionality described herein, for example various blocks illustrated in either of, or both of, FIGS. 1 and 2. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in random access memory (RAM), flash memory, read only memory (ROM), erasable programmable read-only memory (EPROM), electrically erasable programmable read-only memory (EEPROM), registers, hard disk, a removable disk, a compact disc read only memory (CD-ROM), digital versatile disc (DVD), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for determining a time domain peak using multiple time domain radio frequency (RF) signals, the method comprising:
receiving a first time domain RF signal;
converting, the first time domain RF signal from a time based domain to a frequency based domain;
receiving a second time domain RF signal, sampled at a time after the first time domain RF signal;
converting the second time domain RF signal from the time based domain to the frequency based domain;
combining at least the converted first RF signal and the converted second RF signal into a combined RF signal, wherein one or both of: the converted first RF signal, or the converted second RF signal are rotated in the frequency domain for the combining; and
determining a refined time domain peak from the combined RF signal.

2. The method of claim 1, further comprising:
determining an amount for the rotation.

3. The method of claim 2, wherein determining the amount for the rotation comprises:
performing IFFT; and
estimating a time domain peak.

4. The method of claim 1, wherein determining the refined time domain peak comprises performing IFFT on the combined converted RF signals.

5. The method of claim 1, wherein the second time domain RF signal comprises a same frequency block as the first time domain RF signal.

6. The method of claim 1, further comprising:
receiving a third time domain RF signal sampled after the first time domain RF signal and after the second time domain RF signal, wherein the third time domain RF signal comprises a different frequency block than one or both of the first RF signal or the second RF signal;
performing FFT of the third time domain RF signal; and
combining the third frequency based RF signal with the first time domain RF signal or the time domain second RF signals in the frequency domain, wherein the determining a refined time domain peak is according to the combined RF signal that includes the third frequency based RF signal.

7. A low power device for determining a location using low bandwidth signals comprising:
memory;
an RF transceiver for receiving RF signals; and
a processor coupled to the memory and to the RF transceiver and configured to:
receive a first time domain RF signal;
convert, the first time domain RF signal from a time based domain to a frequency based domain;
receive a second time domain RF signal, sampled at a time after the first time domain RF signal;
convert the second time domain RF signal from the time based domain to the frequency based domain;
combine at least the converted first RF signal and the converted second RF signal into a combined RF signal, wherein one or both of: the converted first RF signal, or the converted second RF signal are rotated in the frequency domain for the combining; and
determine a refined time domain peak from the combined RF signal.

8. The device of claim 7, the processor coupled to the memory and to the RF transceiver further configured to:
determine an amount for the rotation.

9. The device of claim 8, wherein the processor coupled to the memory and to the RF transceiver configured to determine the amount for the rotation comprises the processor coupled to the memory and to the RF transceiver configured to:
perform IFFT; and
estimate a time domain peak.

10. The device of claim 7, wherein the processor coupled to the memory and to the RF transceiver configured to determine the refined time domain peak comprises the processor coupled to the memory and to the RF transceiver configured to perform IFFT on the combined converted RF signals.

11. The device of claim 7, wherein the second time domain RF signal comprises a same frequency block as the first time domain RF signal.

12. The device of claim 7, the processor coupled to the memory and to the RF transceiver further configured to:
receive a third time domain RF signal sampled after the first time domain RF signal and after the second time domain RF signal, wherein the third time domain RF signal comprises a different frequency block than one or both of the first RF signal or the second RF signal;
perform FFT of the third time domain RF signal; and
combine the third frequency based RF signal with the first time domain RF signal or the time domain second RF signals in the frequency domain, wherein the processor coupled to the memory and to the RF transceiver configured to determine the refined time domain peak comprises the processor coupled to the memory and to the RF transceiver configured to determine the refined time domain peak according to the combined RF signal that includes the third frequency based RF signal.

13. A machine readable non-transitory storage medium having stored therein program instructions that are executable by one or more processors, the program instructions including instructions for the one or more processors to:
receive a first time domain RF signal;
convert, the first time domain RF signal from a time based domain to a frequency based domain;
receive a second time domain RF signal, sampled at a time after the first time domain RF signal;
convert the second time domain RF signal from the time based domain to the frequency based domain;
combine at least the converted first RF signal and the converted second RF signal into a combined RF signal, wherein one or both of: the converted first RF signal, or the converted second RF signal are rotated in the frequency domain for the combining; and
determine a refined time domain peak from the combined RF signal.

14. The medium of claim 13, further comprising instructions for the one or more processors to:
determine an amount for the rotation.

15. The medium of claim 14, wherein the instructions for the one or more processors to determine the amount for the rotation comprises instructions for the one or more processors to:
perform IFFT; and
estimate a time domain peak.

16. The medium of claim 13, wherein the instructions for the one or more processors to determine the refined time domain peak comprises instructions for the one or more processors to perform IFFT on the combined converted RF signals.

17. The medium of claim 13, wherein the second time domain RF signal comprises a same frequency block as the first time domain RF signal.

18. The medium of claim 13, further comprising instructions for the one or more processors to:
receive a third time domain RF signal sampled after the first time domain RF signal and after the second time domain RF signal, wherein the third time domain RF signal comprises a different frequency block than one or both of the first RF signal or the second RF signal;
perform FFT of the third time domain RF signal; and
combining the third frequency based RF signal with the first time domain RF signal or the time domain second RF signals in the frequency domain, wherein the determining a refined time domain peak is according to the combined RF signal that includes the third frequency based RF signal.

19. An apparatus for determining a location using low bandwidth signals, the apparatus comprising:
means for receiving a first time domain RF signal;
means for converting, the first time domain RF signal from a time based domain to a frequency based domain;
means for receiving a second time domain RF signal, sampled at a time after the first time domain RF signal;
means for converting the second time domain RF signal from the time based domain to the frequency based domain;
means for combining at least the converted first RF signal and the converted second RF signal into a combined RF signal, wherein one or both of: the converted first RF signal, or the converted second RF signal are rotated in the frequency domain for the combining; and
means for determining a refined time domain peak from the combined RF signal.

20. The apparatus of claim 19, further comprising:
means for determining an amount for the rotation.

21. The apparatus of claim 20, wherein the means for determining the amount for the rotation comprises:
means for performing IFFT; and
means for estimating a time domain peak.

22. The apparatus of claim 19, wherein the means for determining the refined time domain peak comprises means for performing IFFT on the combined converted RF signals.

23. The apparatus of claim 19, wherein the second time domain RF signal comprises a same frequency block as the first time domain RF signal.

24. The apparatus of claim 19, further comprising:
means for receiving a third time domain RF signal sampled after the first time domain RF signal and after the second time domain RF signal, wherein the third time domain RF signal comprises a different frequency block than one or both of the first RF signal or the second RF signal;
means for performing FFT of the third time domain RF signal; and
means for combining the third frequency based RF signal with the first time domain RF signal or the time domain second RF signals in the frequency domain, wherein the determining a refined time domain peak is according to the combined RF signal that includes the third frequency based RF signal.
